(19) United States
(12) Patent Application Publication
(10) Pub. No.: US 2018/0159184 A1
(43) Pub. Date: Jun. 7, 2018

(54) POWER SUPPLY CONTROL DEVICE, POWER SUPPLY SYSTEM, POWER SUPPLY CONTROL METHOD, AND PROGRAM

(71) Applicant: MITSUBISHI HEAVY INDUSTRIES, LTD., Tokyo (JP)

(72) Inventors: Takehiko Nishida, Tokyo (JP); Masayuki Hashimoto, Tokyo (JP); Yusuke Yashiro, Tokyo (JP)

(73) Assignee: MITSUBISHI HEAVY INDUSTRIES, LTD., Tokyo (JP)

(21) Appl. No.: 15/575,608

(22) PCT Filed: May 23, 2016
(86) PCT No.: PCT/JP2016/065136

§ 371 Date: Nov. 20, 2017

(30) Foreign Application Priority Data
May 22, 2015 (JP) 2015-104745

(51) Int. Cl. H01M 10/44; H01M 10/42; G05B 13/02

(52) U.S. Cl. CPC H01M 10/44; H01M 2010/4271; G05B 13/026; H01M 10/425

(57) ABSTRACT

A power supply control device includes an SOC schedule generation unit configured to generate an SOC schedule indicating a change in an SOC of a power storage device in a first period when a power supply system including the power storage device is operated such that an SOC of the power storage device does not fall outside of a predetermined range, an operation schedule generation unit configured to generate an operation schedule of the power supply system in a second period which is a period within the first period on the basis of the SOC schedule and a control command unit configured to generate a control command of the power supply system on the basis of the operation schedule.

### TECHNICAL FIELD

The present invention relates to a power supply control device, a power supply system, a power supply control method, and a program. This application claims priority based on Japanese Patent Application No. 2015-104745 filed in Japan on May 22, 2015, the entire content of which is incorporated herein by reference.

### BACKGROUND ART

Power supply systems for the purpose of stabilizing electricity supply such as by suppressing fluctuations in generated power of renewable energy power generation equipment or a peak cut of demanded power are known. Such a power supply system includes a power storage device for appropriately performing charging or discharging with respect to fluctuations in power supply and demand. In such a power supply system, it is necessary to appropriately manage an SOC (a state of charge) of the power storage device such that the SOC of the power storage device does not exceed an upper limit of use or fall below a lower limit of use.

Patent Document 1 discloses a technology of charging a power storage device before the start of an operation period such that the capacity of the power storage device is a necessary storage capacity at an initial time of the operation period.

### CITATION LIST

### Patent Document

### Patent Document

[Patent Document 1] Japanese Unexamined Patent Application, First Publication No. 2012-120419

### SUMMARY OF INVENTION

### Technical Problem

According to the technology described in Patent Document 1, it is possible to prevent the capacity of a power storage device in an operation period of a power supply system from exceeding an upper limit of use or falling below lower limit of use. On the other hand, according to the technology described in Patent Document 1, it is necessary to provide an adjustment period for adjusting the capacity of a power storage device before the start of an operation period. As a result, it is difficult to apply the technology described in Patent Document 1 to a power supply system in which it is necessary to constantly perform power supply control as a main purpose.

An object of the present invention is to provide a power supply control device, a power supply system, a power supply control method, and a program, which appropriately manage an SOC of a power storage device included in the power supply system in which power supply control is constantly performed as a main purpose.

### Solution to Problem

According to a first aspect of the present invention, a power supply control device which controls a power supply system including a power storage device includes an SOC schedule generation unit configured to generate an SOC schedule indicating a change in an SOC of the power storage device in a first period when the power supply system is operated such that an SOC of the power storage device does not fall outside of a predetermined range, an operation schedule generation unit configured to generate an operation schedule of the power supply system in a second period which is a period within the first period on the basis of the SOC schedule, and a control command unit configured to generate a control command of the power supply system on the basis of the operation schedule.

According to a second aspect of the present invention, in the power supply control device according to the first aspect, the SOC schedule generation unit may generate the SOC schedule in the first period when the power supply system is operated such that an SOC of a power storage device does not fall outside of a predetermined range and an SOC of the power storage device at an end point of the first period is a predetermined target SOC.

According to a third aspect of the present invention, in the power supply control device according to the second aspect, the operation schedule generation unit may generate the operation schedule such that an SOC of the power storage device at an end point of the second period is an SOC of the power storage device at an end point of the second period in the SOC schedule.

According to a fourth aspect of the present invention, in the power supply control device according to the third aspect, the operation schedule generation unit may generate the operation schedule such that an SOC of the power storage device at a start point of the second period is an actual SOC at the time of the start point.

According to a fifth aspect of the present invention, in the power supply control device according to any one of the first to fourth aspects, the operation schedule may include a change in a power generation amount of a plurality of power generators included in the power supply system, and the operation schedule generation unit may generate the operation schedule to optimize an efficiency of the plurality of power generators included in the power supply system.

According to a sixth aspect of the present invention, the power supply control device according to any one of the first to fifth aspects further includes a supply and demand prediction unit configured to predict a change in power supply and demand of equipment in a prediction period including the first period, in which the SOC schedule generation unit may generate the SOC schedule on the basis of a result of the prediction, and the operation schedule generation unit may generate the operation schedule on the basis of a result of the prediction.

According to a seventh aspect of the present invention, a power supply system connected to equipment in which power supply and demand fluctuates includes a power storage device, a power generator capable of controlling generated power, and the power supply control device described in any one of claims 1 to 6.

According to an eighth aspect of the present invention, a power supply control method of a power supply system including a power storage device includes generating an SOC schedule which indicates a change in an SOC of the power storage device in a first period when the power supply system is operated such that the SOC of the power storage device does not fall outside of a predetermined range, generating an operation schedule of the power supply system in a second period which is a period within the first period on the basis of the SOC schedule, and generating a control command of the power supply system on the basis of the operation schedule.

According to a ninth aspect of the present invention, a program causes a computer provided in a power supply system including a power storage device to function as an SOC schedule generation unit configured to generate an SOC schedule indicating a change in an SOC of the power storage device in a first period when the power supply system is operated such that the SOC of the power storage device does not fall outside of a predetermined range, an operation schedule generation unit configured to generate an operation schedule of the power supply system in a second period which is a period within the first period on the basis of the SOC schedule, and a control command unit configured to generate a control command of the power supply system on the basis of the operation schedule.

### Advantageous Effects of Invention

According to at least one of the aspects described above, a power supply control device generates an operation schedule of a power supply system in a second period which is a period within a first period on the basis of an SOC schedule for the first period generated such that an SOC does not fall outside of a predetermined range. Accordingly, the power supply control device can control an SOC of a power storage device such that an SOC of the power storage device does not fall outside of a predetermined range even in a power supply system in which it is necessary to constantly perform power supply control as a main purpose.

### BRIEF DESCRIPTION OF DRAWINGS

FIG. 1 is a block diagram which shows a configuration of a power supply system according to a first embodiment.

FIG. 2 is a flowchart which shows a required power calculation process according to the first embodiment.

FIG. 3 is a flowchart which shows an SOC schedule generation process according to the first embodiment.

FIG. 4 is a flowchart which shows an operation schedule generation process according to the first embodiment.

FIG. 5 is a diagram which shows an example of an operation schedule generated by a power supply control device according to the first embodiment.

FIG. 6 is a schematic block diagram which shows a configuration of a computer according to at least one embodiment.

### DESCRIPTION OF EMBODIMENTS

### First Embodiment

Hereinafter, embodiments will be described in detail with reference to the drawings.

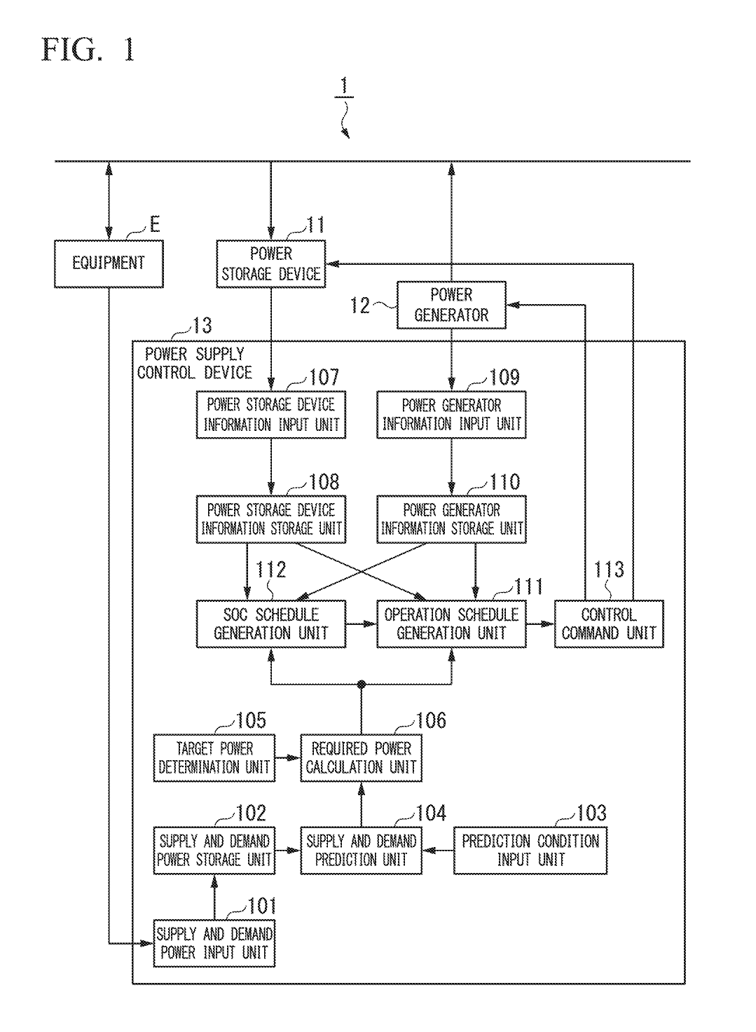

FIG. 1 is a block diagram which shows a configuration of a power supply system according to a first embodiment.

A power supply system 1 according to the present embodiment is connected to equipment E in which power supply and demand fluctuate. The equipment E is, for example, equipment in which generated power fluctuates, such as renewable energy power generation equipment, equipment in which demanded power fluctuates, such as demand equipment, or a combination of these. The power supply system 1 includes a power storage device 11, a power generator 12, and a power supply control device 13.

The power storage device 11 is a device for storing power generated by the equipment E and the power generator 12. The power storage device 11 is mounted on a secondary battery such as a lithium ion battery or a capacitor such as an electric double layer capacitor.

The power generator 12 is a power generator capable of controlling generated power. The power generator 12 is mounted on, for example, a gas turbine power generation plant and the like.

The power supply control device 13 controls a power generation amount of the power generator 12 on the basis of power supply and demand of the equipment E and an SOC of the power storage device 11.

The power supply control device 13 includes a supply and demand power input unit 101, a supply and demand power storage unit 102, a prediction condition input unit 103, a supply and demand prediction unit 104, a target power determination unit 105, a required power calculation unit 106, a power storage device information input unit 107, a power storage device information storage unit 108, a power generator information input unit 109, a power generator information storage unit 110, an SOC schedule generation unit 111, an operation schedule generation unit 112, and a control command unit 113.

The supply and demand power input unit 101 receives an input of information on supply and demand power which is generated power and demanded power by the equipment E.

The supply and demand power storage unit 102 stores information on supply and demand power input to the supply and demand power input unit 101.

The prediction condition input unit 103 receives an input of prediction conditions used to predict supply and demand power of the equipment E. Examples of prediction conditions include weather prediction information used to predict power generation of renewable energy, and calendar information (season, month, day of week, and the like) used to predict demanded power.

The supply and demand prediction unit 104 predicts fluctuations in the supply and demand power of the equipment E in a prediction period (for example, a period of one month from a current time) on the basis of information stored in the supply and demand power storage unit 102 and information input to the prediction condition input unit 103.

The target power determination unit 105 determines target power on the basis of a power command input from the outside or a control condition of the power supply system 1. Examples of the control conditions of the power supply system 1 include an upper limit power of peak cut, a fluctuation width of system power, and the like.

The required power calculation unit 106 calculates required power which is power with which the power storage device 11 requires to be charged or power which is required to be generated by the power generator 12 by calculating a difference between target power determined by the target power determination unit 105 and supply and demand power predicted by the supply and demand prediction unit 104.

The power storage device information input unit 107 receives a notification of a state of the power storage device 11 at a current time from the power storage device 11. Examples of the state of the power storage device 11 include fault information and degradation information of the power storage device 11.

The power storage device information storage unit 108 stores device characteristics and constraints of the power storage device 11, and a state of the power storage device 11. Examples of the device characteristics of the power storage device 11 include charge and discharge efficiency and response characteristics. Examples of the constraints of the power storage device 11 include an operation range (an upper limit of an operation and a lower limit of an operation) of an SOC. The operation range of an SOC is an example of a predetermined range which is an operation limit of a storage battery.

The power generator information input unit 109 receives a notification of a state of the power generator 12 at a current time from the power generator 12. Examples of the state of the power generator 12 include fault information of the power generator 12 and information concerning whether the power generator 12 operates.

The power generator information storage unit 110 stores device characteristics and constraints of the power generator 12, and a state of the power generator 12. Examples of the device characteristics of the power generator 12 include response characteristics of the power generator 12. Examples of the constraints of the power generator 12 include maximum generated power.

The SOC schedule generation unit 111 determines an optimum solution or an approximate solution for an operation of the power supply system 1 in a first period by simulating an operation of the power supply system 1 in the first period (for example, one day) on the basis of required power calculated by the required power calculation unit 106, and the device characteristics, the constraints, and the state stored by the power storage device information storage unit 108 and the power generator information storage unit 110. The SOC schedule generation unit 111 generates a schedule of the SOC of the power storage device 11 in the first period on the basis of the determined operation of the power supply system 1. The first period is a period shorter than a prediction period (for example, one month).

The operation schedule generation unit 112 determines an optimum solution or an approximate solution for the operation of the power supply system 1 in a second period by simulating the operation of the power supply system 1 in the second period (for example, one hour) on the basis of the required power calculated by the required power calculation unit 106, the device characteristics, the constraints, and the state stored by the power storage device information storage unit 108 and the power generator information storage unit 110, and the schedule of the SOC generated by the SOC schedule generation unit 111. The SOC schedule generation unit 111 generates a schedule of the SOC of the power storage device 11 in the second period on the basis of the determined operation of the power supply system 1. The second period is a period within the first period, and the length of the first period is an integral multiple of the length of the second period.

The control command unit 113 controls charging or discharging of the power storage device 11 and power generation of the power generator 12 on the basis of an operation schedule generated by the operation schedule generation unit 112.

Next, an operation of the power supply control device 13 according to the present embodiment will be described.

The power supply control device 13 repeatedly executes each of an update process, a required power calculation process, an SOC schedule generation process, an operation schedule generation process, and a power control process in parallel.

The update process is a process of maintaining information stored by the supply and demand power storage unit 102, the power storage device information storage unit 108, and the power generator information storage unit 110 in a latest state. The update process is executed every predetermined update cycle (for example, one minute).

The required power calculation process is a process of predicting change in required power in a prediction period. The required power calculation process is executed every cycle (for example, one hour) shorter than the length of the first period.

The SOC schedule generation process is a process of generating an SOC schedule indicating a change in the SOC of the power storage device 11 in the first period. The SOC schedule generation process is executed every cycle (for example, one day) with the same length as that of the first period.

The operation schedule generation process is a process of generating an operation schedule of the power storage device 11 and the power generator 12 in the second period. The operation schedule generation process is executed every cycle with the same length as that of the second period.

The power control process is a process of outputting a charging or discharging command to the power storage device 11 and outputting a power generation command to the power generator 12. The power control process is executed every predetermined control cycle (for example, one minute).

The update process will be described.

The equipment E notifies the power supply control device 13 of supply and demand power of the equipment E every update cycle. If the supply and demand power input unit 101 of the power supply control device 13 receives the notification of supply and demand power, the supply and demand power input unit 101 records information indicating supply and demand power in the supply and demand power storage unit 102 in correlation with a current time. As a result, fluctuations in past supply and demand power of the equipment E are accumulated in the supply and demand power storage unit 102. At this time, the supply and demand power input unit 101 stores related information which may be related to supply and demand power such as weather information or calendar information at that time in the supply and demand power storage unit 102 in correlation with information indicating the supply and demand power. The related information is information corresponding to a prediction condition. In addition, the power storage device 11 and the power generator 12 notify the power supply control device 13 of the states thereof for each update cycle. The power storage device information input unit 107 updates the state of the power storage device 11 stored by the power storage device information storage unit 108 on the basis of the notification. The power generator information input unit 109 updates the state of the power generator 12 stored by the power generator information storage unit 110 on the basis of the notification.

The required power calculation process will be described.

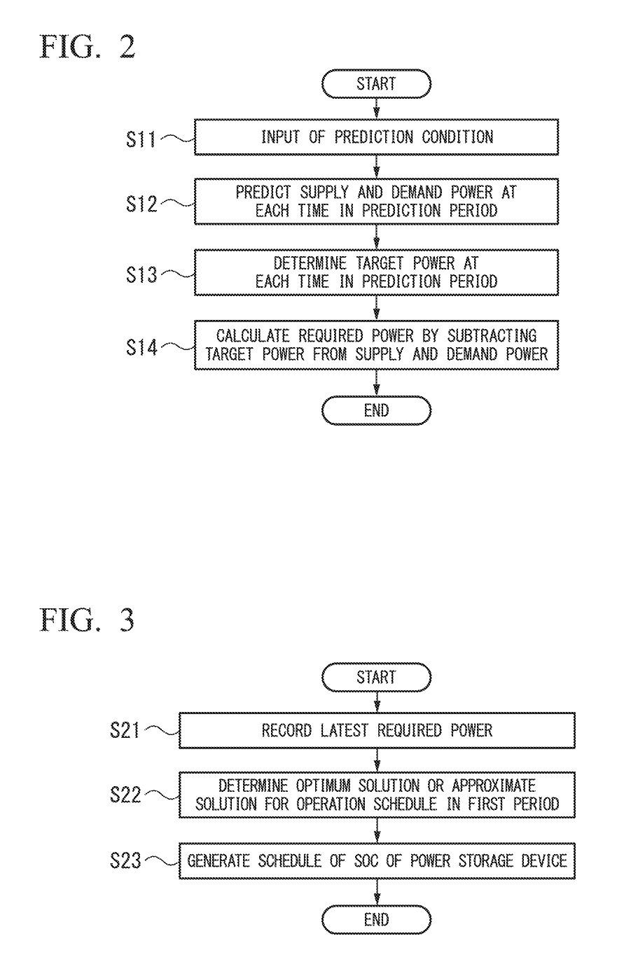

FIG. 2 is a flowchart which shows the required power calculation process according to the first embodiment.

First, the prediction condition input unit 103 receives an input of a prediction condition used to predict supply and demand power (step S11). For example, the prediction condition input unit 103 receives weather information from an external weather prediction system. Next, the supply and demand prediction unit 104 predicts supply and demand power (a change in supply and demand power) at each time in a predetermined prediction period on the basis of a history of supply and demand power stored by the supply and demand power storage unit 102 and a prediction condition input to the prediction condition input unit 103 (step S12). For example, the supply and demand prediction unit 104 can predict supply and demand power correlated with related information similar to a prediction condition input to the prediction condition input unit 103 and supply and demand power at that time at each time in a prediction period. A measurement period of supply and demand power accumulated in the supply and demand power storage unit 102 is longer than the prediction period, and thereby prediction accuracy by the supply and demand prediction unit 104 increases.

In addition, the target power determination unit 105 determines the target power at each time in the prediction period on the basis of a power command input from the outside or the control condition of the power supply system 1 (step S13). Next, the required power calculation unit 106 subtracts target power determined by the target power determination unit 105 from a prediction result of supply and demand power received by the supply and demand prediction unit 104 to calculate required power (step S14). That is, the required power calculation unit 106 determines required power at each time in the prediction period. Positive required power indicates power to be stored in the power storage device 11 and negative required power indicates power to be generated by the power generator 12.

The supply and demand prediction unit 104 predicts supply and demand power on the basis of a new prediction condition whenever the required power calculation process is executed. For this reason, prediction accuracy of demanded power at the same time is expected to increase whenever the required power calculation process is executed. The supply and demand prediction unit 104 according to other embodiments may not necessarily predict supply and demand power whenever the required power calculation process is executed. Specifically, at a timing of the required power calculation process, supply and demand power related to a period longer than the process period may also be predicted.

The SOC schedule generation process will be described.

FIG. 3 is a flowchart which shows the SOC schedule generation process according to the first embodiment.

The SOC schedule generation unit 111 temporarily records latest required power corresponding to the first period calculated by the required power calculation unit 106 in a region for an SOC schedule generation process of a main storage device if the SOC schedule generation process starts (step S21). Accordingly, even if required power is updated by the required power calculation process during calculation of the SOC schedule generation process, the SOC schedule generation unit 111 can continue the SOC schedule generation process using required power at the time of the start of the SOC schedule generation process.

The SOC schedule generation unit 111 determines an optimum solution or an approximate solution for an operation schedule of the power supply system 1 in the first period which is a period in the prediction period on the basis of the required power recorded in a main storage device and the device characteristics, the constraints, and the state stored by the power storage device information storage unit 108 and the power generator information storage unit 110 (step S22). At this time, the SOC schedule generation unit 111 determines an optimum solution or an approximate solution for the operation schedule of the power supply system 1 such that the SOC of the power storage device 11 does not exceed the upper limit of the operation of the power storage device 11, the SOC of the power storage device 11 does not fall below the lower limit of the operation of the power storage device 11, and the SOC of the power storage device 11 becomes a target SOC (for example, 50%) at the end point of the first period. The SOC schedule generation unit 111 sets the SOC of the power storage device 11 at an initial time to the same SOC as the target SOC and calculates an operation schedule of the power supply system 1.

A method of determining the optimum solution or the approximate solution for the operation of the power supply system 1 includes, for example, deterministic algorithms such as a joint method, Newton's method, a steepest descent method, and a downhill simplex method or probabilistic algorithms such as an annealing method and a genetic algorithm. Such approximate solution search algorithms have an increased calculation time as the number of variables increases. Therefore, as an operation schedule setting target period is longer, time taken to determine the optimum solution or the approximate solution for the operation schedule increases. When the length of the first period is, for example, 24 hours, the SOC schedule generation unit 111 according to the present embodiment determines an optimum solution or an approximate solution for the operation schedule of the power supply system 1 over a maximum of 24 hours. Therefore, the SOC schedule generation unit 111 calculates the start point of the first period as a time after a time at which determination of the optimum solution or the approximate solution for the operation schedule of the first period is completed. Predetermined requirements of the power supply system 1 are used for evaluation of the operation schedule. Examples of the requirements include minimizing integrated power generation cost of the first period and minimizing an energy loss in the first period.

If the SOC schedule generation unit 111 determines the optimum solution or the approximate solution, the SOC schedule generation unit 111 generates a change in the SOC of the power storage device 11 when the power supply system 1 is operated according to an operation schedule related to the optimum solution or the approximate solution as a schedule of the SOC of the power storage device 11 (step S23).

The operation schedule generation process will be described.

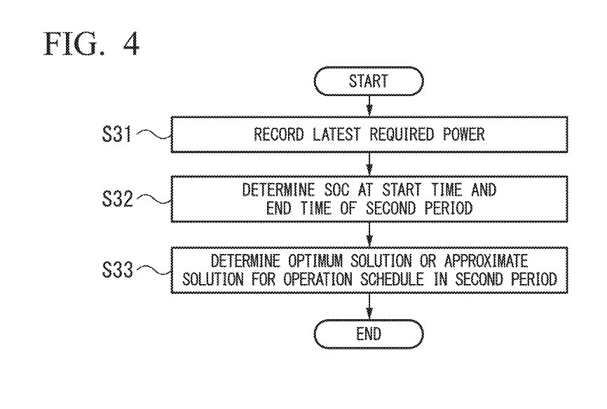

FIG. 4 is a flowchart which shows the operation schedule generation process according to the first embodiment.

The operation schedule generation unit 112 temporarily records latest required power calculated by the required power calculation unit 106 in a region of the main storage device for the operation schedule generation process if the operation schedule generation process starts (step S31). Accordingly, even if the required power is updated by the required power calculation process during calculation of the operation schedule generation process, the operation schedule generation unit 112 can continue the operation schedule generation process using required power at the time of the start of the SOC schedule generation process.

The operation schedule generation unit 112 determines the SOC of the power storage device 11 at a start point and an end point of the second period from the SOC operation schedule of the first period generated by the SOC schedule generation unit 111 (step S32). Next, the operation schedule generation unit 112 determines an optimum solution or an approximate solution for the operation schedule of the power supply system 1 for the second period which is a period in the first period on the basis of required power recorded in the main storage device and the device characteristics, the constraints, and the state stored by the power storage device information storage unit 108 and the power generator information storage unit 110 (step S33). At this time, the operation schedule generation unit 112 determines the optimum solution or the approximate solution for the operation schedule of the power supply system 1 such that the SOC of the power storage device 11 does not exceed the upper limit of the operation of the power storage device 11, the SOC of the power storage device 11 does not fall below the lower limit of the operation of the power storage device 11, and the SOC of the power storage device 11 at the end point of the second period is the SOC read in step S32. The operation schedule generation unit 112 sets the SOC of the power storage device 11 at an initial time to the SOC at the start point of the second period read in step S32, and calculates an operation schedule of the power supply system 1. Predetermined requirements of the power supply system 1 are used for evaluation of the operation schedule. Examples of the requirements include minimizing integrated power generation cost, minimizing an energy loss in the second period and the like.

As methods of determining the optimum solution or the approximate solution for the operation of the power supply system 1, a deterministic algorithm or a probabilistic algorithm can be used in the same manner as in the SOC schedule generation process. The operation schedule generation unit 112 according to the present embodiment determines the optimum solution or the approximate solution for the operation schedule of the power supply system 1 over one minute when the length of the second period is, for example, one hour. Therefore, the operation schedule generation unit 112 calculates the start point of the second period as a time after a time at which determination of the optimum solution or the approximate solution for the operation schedule of the second period is completed.

The power control process will be described.

The control command unit 113 acquires an operation schedule for the second period generated by the operation schedule generation unit 112. Next, the control command unit 113 outputs a charging or discharging command according to a current time to the power storage device 11 from the acquired operation schedule or outputs a power operation command according to a current time to the power generator 12.

Here, a reason for which it is possible to appropriately control the power supply system 1 using the power supply control device 13 according to the present embodiment will be described.

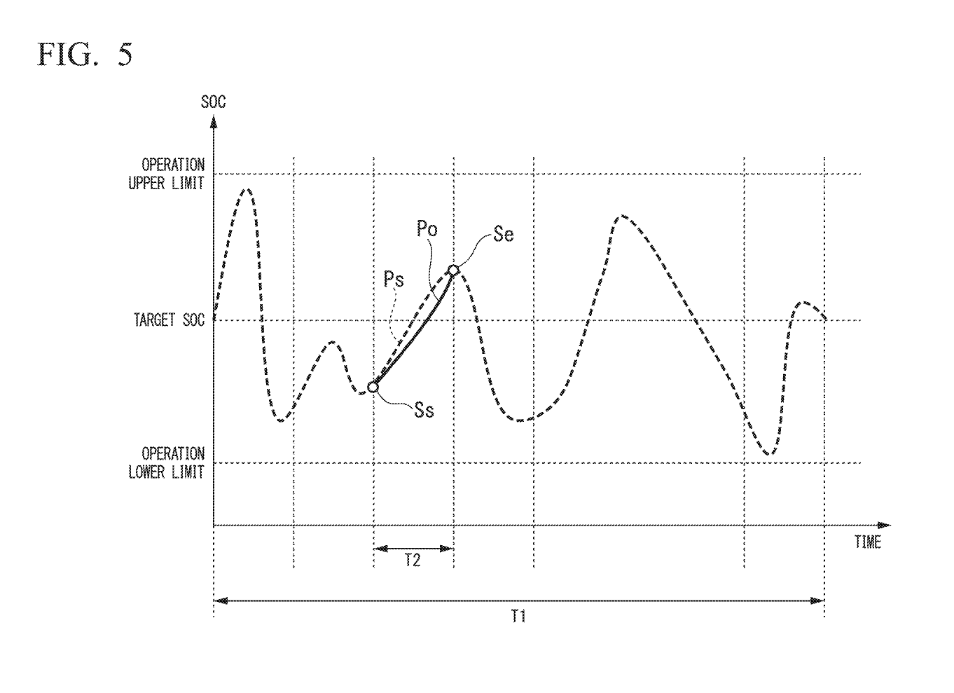

FIG. 5 is a diagram which shows an example of an operation schedule generated by a power supply control device according to the first embodiment.

The SOC schedule generation unit 111 generates an SOC schedule Ps in the first period T1 in the SOC schedule generation process described above. In addition, the operation schedule generation unit 112 determines a start SOC Ss which is an SOC of the power storage device 11 according to the start point of the second period T1 and an end SOC Se which is an SOC of the power storage device 11 according to the end point in the operation schedule generation process described above. Then, the operation schedule generation unit 112 generates an operation schedule of the power supply system 1 on the basis of the start SOC Ss and the end SOC Se. A change Po in the SOC of the power storage device 11 when the power storage device 11 is operated according to the operation schedule does not necessarily match the SOC schedule Ps as shown in FIG. 5. This is because required power is updated in the required power calculation process from a time when the SOC schedule generation unit 111 starts to generate an SOC schedule for the first period T1 to a time when the operation schedule generation unit 112 starts to generate an operation schedule for the second period T2. As a result, the operation schedule generation unit 112 can generate an operation schedule which satisfies the requirements better than an operation schedule generated by the SOC schedule generation unit 111 in the SOC schedule generation process.

On the other hand, the SOC schedule generation unit 111 generates an SOC schedule in which an SOC of the power storage device 11 is operated in a range equal to or greater than an operation lower limit value and equal to or less than an operation upper limit value, and SOCs of the power storage device 11 at the start point and the end point become a target SOC for the first period which is a period including the second period T2. If the SOCs of the power storage device 11 at the start point and the end point become the target SOC, as time from the start point to the end point is longer, it is possible to effectively use the capacity of the power storage device 11.

Therefore, the power supply control device 13 generates an SOC schedule for the first period longer than the second period, and generates an operation schedule of the first period on the basis of a generated charging or discharging schedule, and thereby it is possible to effectively use the capacity of the power storage device 11 and to generate an operation schedule which satisfies the requirements better.

### Second Embodiment

Hereinafter, the second embodiment will be described.

The operation schedule generation unit 112 according to the first embodiment generates an operation schedule for the second period on the basis of an SOC of the power storage device 11 at the start point of the second period and an SOC of the power storage device 11 at the end point of the second period in an SOC schedule. In contrast, an operation schedule generation unit 112 according to the second embodiment generates an operation schedule for the second period on the basis of an SOC of the power storage device 11 at the end point of the second period in an SOC and an SOC schedule at a current time. A configuration of the power supply system 1 according to the second embodiment is the same as that of the first embodiment.

In the first embodiment, the operation schedule generation unit 112 calculates the start point of the second period as a time after the time at which determination of an optimum solution or an approximate solution for the operation schedule of the second period is completed. In contrast, the operation schedule generation unit 112 according to the second embodiment calculates the start point of the second period as a time at which determination of an optimum solution or an approximate solution for the operation schedule of the second period starts. Accordingly, the operation schedule generation unit 112 can generate the operation schedule of the second period on the basis of an actual SOC of the power storage device 11. Therefore, the operation schedule generation unit 112 according to the present embodiment can generate an operation schedule which satisfies requirements better. If the length of the second period is sufficiently short, a search time for the optimum solution or the approximate solution by the operation schedule generation unit 112 is short. As a result, even when the operation schedule of the second period is generated at the start point of the second period, this does not interfere with control of the power supply system 1.

### Third Embodiment

Hereinafter, the third embodiment will be described.

A power supply system 1 according to the third embodiment includes a plurality of power storage devices 11 and power generators 12.

An SOC schedule generation unit 111 and an operation schedule generation unit 112 of a power supply control device 13 according to the third embodiment generate an operation schedule for optimizing a share of charging or discharging of the plurality of power storage devices 11 and a share of a power generation amount of the plurality of power generators 12. As a result, the power supply control device 13 can cause the power supply system 1 to be operated on the basis of an operation schedule in which an energy loss is minimized.

In the present embodiment, the power supply system 1 includes a plurality of power storage devices 11 and power generators 12, but the present invention is not limited thereto. For example, the power supply system according to other embodiments may include a plurality of either power storage devices 11 or power generators 12 only.

### Fourth Embodiment

Hereinafter, a fourth embodiment will be described.

The operation schedule generation unit 112 according to the third embodiment generates an operation schedule for the second period on the basis of an SOC of the power storage device 11 at the start point of the second period and an SOC of the power storage device 11 at the end point of the second period in an SOC schedule in the same manner as in the first embodiment. On the other hand, since the power supply system 1 according to the third embodiment includes a plurality of power storage devices 11 and the power generators 12, a calculation time of the optimum solution or the approximate solution for an operation schedule is longer than in the first embodiment. For this reason, generation of an operation schedule in a period until the start point of the second period may not be performed in time due to the length of the second period.

In contrast, the operation schedule generation unit 112 according to the fourth embodiment generates an operation schedule such that an SOC of the power storage device 11 at each time of the second period is equal to the SOC schedule. That is, the operation schedule generation unit 112 sets an SOC of the power storage device 11 at each time to a constant and sets a share of charging or discharging of the plurality of power storage devices 11 and a share of a power generation amount of the plurality of power generators 12 to a variable, thereby determining the optimum solution or approximate solution for the operation schedule of the second period. As a result, the operation schedule generation unit 112 according to the fourth embodiment can reduce a calculation amount related to calculation of the optimum solution or approximate solution for the operation schedule of the second period, and shorten a calculation time of the operation schedule of the second period.

Embodiments have been described above in detail with reference to the drawings, but a specific configuration is not limited to those described above and various design changes and the like can be made.

For example, the SOC schedule generation unit 111 according to the present embodiments described above generates an SOC schedule such that an SOC of the power storage device 11 at the end point of the first period is a target SOC. Accordingly, the SOC schedule generation unit 111 generates an SOC schedule such that an SOC of the power storage device 11 at the end point of the first period is the target SOC, thereby preventing the power storage device 11 from not appropriately operating in a next SOC schedule process. For example, in a next SOC schedule process, it is possible to prevent the power storage device 11 from being unable to be charged because an SOC of the power storage device 11 at the start point of the first period is the operation upper limit or to prevent the power storage device 11 from being unable to be discharged because an SOC of the power storage device 11 at the start point of the first period is the operation lower limit. On the other hand, the SOC schedule generation unit 111 according to other embodiments may generate an SOC schedule without an end condition of the SOC of the power storage device 11.

The length of the first period according to the embodiments described above is an integral multiple of (for example, N times) the length of the second period. As a result, while the SOC schedule generation unit 111 generates an SOC schedule for the first period once, the operation schedule generation unit 112 can generate an SOC schedule for the second period N times. Therefore, the SOC schedule generation unit 111 can ensure calculation time of an SOC schedule for the first period as long as the first period.

On the other hand, the length of the first period according to other embodiments may not be N times the length of the second period. In this case, the SOC schedule generation unit 111 needs to set the calculation time of an SOC schedule for the first period to a time shorter than the first period. For example, when the length of the first period is N times the length of the second period+x, the SOC schedule generation unit 111 needs to generate an SOC schedule for the first period by a time N times the length of the second period.

In addition, the operation schedule generation process according to the embodiments described above is executed every cycle with the same length as the second period, but the invention is not limited thereto. For example, the operation schedule generation unit 112 according to other embodiments may repeatedly execute the operation schedule generation process at a cycle shorter than the length of the second period, and may update an operation schedule in the same period. Accordingly, the power supply control device 13 can satisfy requirements of the operation schedule better.

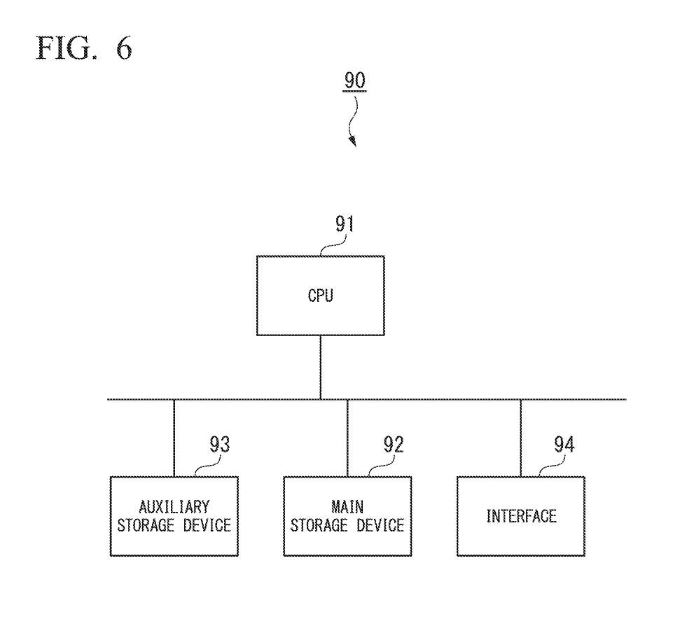

FIG. 6 is a schematic block diagram which shows a configuration of a computer according to at least one of the embodiments.

A computer 90 includes a CPU 91, a main storage device 92, an auxiliary storage device 93, and an interface 94.

The power supply control device 13 described above is mounted on the computer 90. Then, an operation of each process unit described above is stored in the auxiliary storage device 93 in a program form. The CPU 91 reads a program from the auxiliary storage device 93, develops the program in the main storage device 92, and executes the process according to this program. In addition, the CPU 91 ensures a storage region corresponding to each storage unit described above in the main storage device 92 or the auxiliary storage device 93 according to the program.

In at least one embodiment, the auxiliary storage device 93 is an example of a non-transitory tangible medium. Other examples of non-transitory tangible media include a magnetic disk, a magneto-optical disc, a CD-ROM, a DVD-ROM, a semiconductor memory, and the like connected via the interface 94. Moreover, when this program is delivered to the computer 90 via communication lines, the computer 90 which receives this program develops the program in the main storage device 92 and executes the process described above.

In addition, this program may be for realizing some of the functions described above. Furthermore, this program may be a so-called a difference file (differential program) which realizes the functions described above in combination with other programs already stored in the auxiliary storage device 93.

### INDUSTRIAL APPLICABILITY

The power supply control device generates an operation schedule of a power supply system for a second period which is a period in a first period on the basis of an SOC schedule for the first period generated such that an SOC does not fall outside of a predetermined range. As a result, the power supply control device can control an SOC of a power storage device such that an SOC of the power storage device does not fall outside of a predetermined range even in a power supply system in which it is necessary to constantly perform power supply control as a main purpose

### REFERENCE SIGNS LIST

1 Power supply system

11 Power storage device

12 Power generator

13 Power supply control device

111 SOC schedule generation unit

112 Operation schedule generation unit

113 Control command unit

1-9. (canceled)

10. A power supply control device which controls a power supply system including a power storage device, the power supply control device comprising:
an SOC schedule generation unit configured to generate an SOC schedule indicating a change in an SOC of the power storage device in a first period when the power supply system is operated such that an SOC of the power storage device does not fall outside of a predetermined range;
an operation schedule generation unit configured to generate an operation schedule of the power supply system in a second period which is a period within the first period on the basis of the SOC schedule in which an SOC of the power storage device at an end point of the second period matches an SOC of the power storage device at an end point of the second period in the SOC schedule; and
a control command unit configured to generate a control command of the power supply system on the basis of the operation schedule.

11. The power supply control device according to claim 10,
wherein the SOC schedule generation unit is configured to generate the SOC schedule in the first period when the power supply system is operated such that an SOC of a power storage device does not fall outside of a predetermined range and an SOC of the power storage device at an end point of a first period is a predetermined target SOC.

12. The power supply control device according to claim 10,
wherein the operation schedule generation unit is configured to generate the operation schedule such that an SOC of the power storage device at a start point of the second period is an actual SOC at the time of the start point.

13. The power supply control device according to claim 10,
wherein the operation schedule includes a change in a power generation amount of a plurality of power generators included in the power supply system, and
the operation schedule generation unit is configured to generate the operation schedule to optimize an efficiency of the plurality of power generators included in the power supply system.

14. The power supply control device according to claim 10, further comprising:
a supply and demand prediction unit configured to predict a change in power supply and demand of equipment in a prediction period including the first period,
wherein the SOC schedule generation unit is configured to generate the SOC schedule on the basis of a result of the prediction, and
the operation schedule generation unit is configured to generate the operation schedule on the basis of a result of the prediction.

15. A power supply system connected to equipment in which power supply and demand fluctuates, the system comprising:
a power storage device;
a power generator capable of controlling generated power; and
the power supply control device described in claim 10.

16. A power supply control method of a power supply system including a power storage device, the method comprising:
generating an SOC schedule which indicates a change in an SOC of the power storage device in a first period when the power supply system is operated such that the SOC of the power storage device does not fall outside of a predetermined range;
generating an operation schedule of the power supply system in a second period which is a period within the first period on the basis of the SOC schedule in which an SOC of the power storage device at an end point of the second period matches an SOC of the power storage device at an end point of the second period in the SOC schedule; and
generating a control command of the power supply system on the basis of the operation schedule.

17. A program causing a computer provided in a power supply system including a power storage device to function as:
an SOC schedule generation unit configured to generate an SOC schedule indicating a change in an SOC of the power storage device in a first period when the power supply system is operated such that the SOC of the power storage device does not fall outside of a predetermined range;
an operation schedule generation unit configured to generate an operation schedule of the power supply system in a second period which is a period within the first period on the basis of the SOC schedule in which an SOC of the power storage device at an end point of the second period matches an SOC of the power storage device at an end point of the second period in the SOC schedule; and
a control command unit configured to generate a control command of the power supply system on the basis of the operation schedule.
